(19) United States
(12) Patent Application Publication
(10) Pub. No.: US 2009/0145275 A1
(43) Pub. Date: Jun. 11, 2009

(54) ADJUSTABLE SEPARATING PLATE FOR A TABLE SAWING MACHINE

(76) Inventor: Bor-Yann CHUANG, Taiping City (TW)

Correspondence Address: SINORICA, LLC, 528 FALLSGROVE DRIVE, ROCKVILLE, MD, 20850, US

(21) Appl. No.: 11/953,041

(22) Filed: Dec. 8, 2007

(51) Int. Cl. B27B 5/29

(52) U.S. Cl. 83/102

(57) ABSTRACT

An adjustable separating plate for a table sawing machine includes a foundation base fixed inside a table sawing machine. The foundation base has the opposite ends of one side respectively and longitudinally bored with a slide groove, provided with a fixing hole and a position-limiting pin at proper locations. The separating plate is longitudinally bored with a long notch aligned to the fixing hole, and a position-limiting slot matching with the position-limiting pin to be restrictedly positioned on the position-limiting pin. The separating plate restrictedly positioned by the position-limiting pin can vertically be moved on the foundation base along the position-limiting slot and adjusted to a proper height. A fixing member is secured in the fixing hole for fixing the separating plate on the foundation base and enabling it to move restrictedly thereon vertically.

### BACKGROUND OF THE INVENTION

1. Field of the Invention

This invention relates to an adjustable separating plate for a table sawing machine, particularly to one able to be adjusted and used as a separating plate or a dividing plate for carrying out processing of a work piece.

2. Description of the Prior Art

A conventional table sawing machine, as shown in FIG. 1, is provided with a worktable top, as shown in FIG. 1 marked with dotted line (A), and has a separating plate set 1 or a dividing set 2 assembled at a location adjacent to a circular saw blade 3. To use the table sawing machine for cutting a wooden piece with a recess, the separating plate set 1 is optionally assembled at a location adjacent to the circumferential edge of the circular saw blade 3 inside the table sawing machine and has the upper edge (B) of the separating plate set 1 positioned a little lower than the upper end of the circular saw blade 3. Thus, when a wooden piece is moved from the left side to the right side of the work table top, the underside of the wooden piece closely contacting with the work table top (A) will be sawed with a recess by the circular saw blade 3, and then the finished work piece with a recess is conveyed out from the right side of the work table top (A). To use the table sawing machine for cutting a wooden piece into two pieces, the dividing set 2 is optionally assembled adjacent to the circumferential edge of the circular saw blade 3 and the upper edge (C) of the dividing set 2 is positioned somewhat higher than the upper end of the circular saw blade 3. Thus, the wooden piece can be cut into two pieces by the circular saw blade 3 and then sent out from the right side of the work table top (A). However, the separating plate set 1 and the dividing set 2 respectively have only one single function and have to assembled for use independently; therefore, either the separating plate set 1 or the dividing set 2 has to be frequently disassembled and replaced in use, so it is difficult and troublesome to disassemble and re-assemble the separating plate set 1 or the dividing set 2.

### SUMMARY OF THE INVENTION

This invention is advised to offer an adjustable separating plate for a table sawing machine, including a foundation base secured in the interior of a table sawing machine. The foundation base has the opposite ends of one side respectively and longitudinally bored with a slide groove, having a fixing hole and a position-limiting pin disposed at proper locations. A separating plate is longitudinally bored with a long notch with a downward opening at a location corresponding to the fixing hole of the foundation base, and a position-limiting slot at a location matching with the position-limiting pin to be restrictedly positioned by the position-limiting pin. Thus, the separating plate restricted in position by the position-limiting pin can be movably shifted longitudinally on the front side of the foundation base along the position-limiting slot to be adjusted and positioned at a proper height. A fixing member is inserted through the long notch and locked in the fixing hole of the foundation base to enable the separating plate to be adjusted and used as a separating plate or a dividing plate for carrying out processing of a work piece.

### BRIEF DESCRIPTION OF DRAWINGS

This invention will be better understood by referring to the accompanying drawings, wherein:

FIG. 1 is a front view of a separating plate set of a conventional table sawing machine;

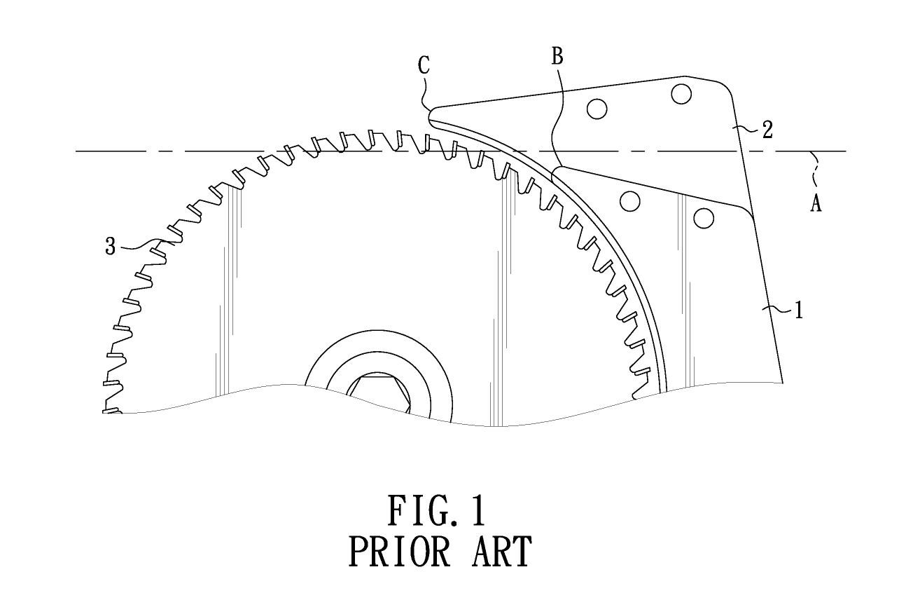

FIG. 2 is a perspective view of a first preferred embodiment of an adjustable separating plate assembled on a table sawing machine in the present invention;

FIG. 3 is a perspective view of the first preferred embodiment of the adjustable separating plate in the present invention;

FIG. 4 is an exploded perspective view of the first preferred embodiment of the adjustable separating plate in the present invention;

FIG. 5 is a side cross-sectional view of the first preferred embodiment of a position-limiting member combined with the adjustable separating plate in the present invention;

FIG. 6 is a cross-sectional view of the first preferred embodiment of the adjustable separating plate moved upward in the present invention;

FIG. 7 is a cross-sectional view of the first preferred embodiment of the adjustable separating plate moved downward in the present invention; and

FIG. 8 is a side cross-sectional view of a second preferred embodiment of a position-limiting pin combined with the adjustable separating plate in the present invention.

### DETAILED DESCRIPTION OF THE PREFERRED EMBODIMENT

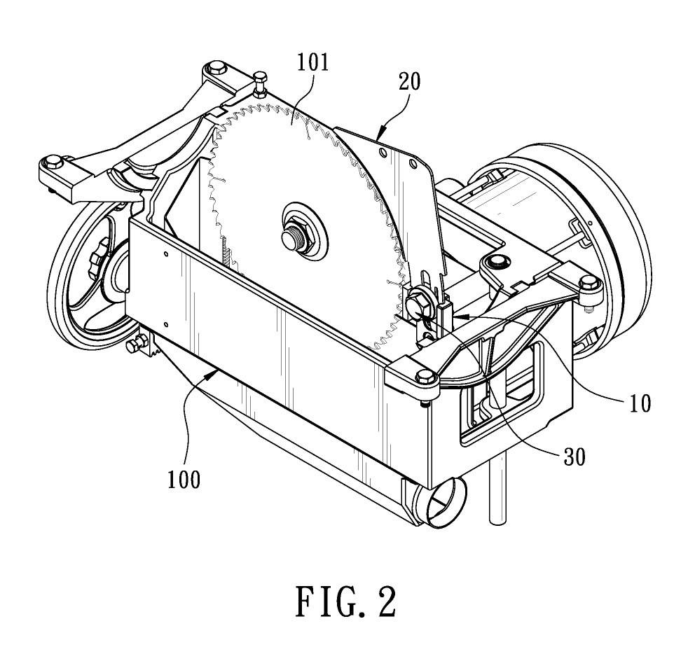

FIG. 2 shows a first preferred embodiment of an adjustable separating plate for a table sawing machine. The adjustable separating plate is secured in the interior of a table sawing machine 100 and positioned near and parallel to a right side of the outer circumference of a circular saw blade 101, including a foundation base 10, a separating plate 20 and a fixing member 30 as main components combined together, as shown in FIGS. 2, 3 and 4.

The foundation base 10 fixed at a right lower end of the outer circumference of the circular saw blade 101 is a rectangular block having the upper left and right end of its front side respectively formed with an L-shaped block 11, 12 protruding forward transversely and parallel to each other. The two L-shaped blocks 11 and 12 have their opposite sides respectively and longitudinally bored with a slide groove 111, 121 facing each other. The two slide grooves 111 and 121 are bent toward a right side to form two long curved grooves for matching with the radian of the outer circumference at the right side of the circular saw blade 101. Further, the foundation base 10 is bored with a fixing hole 13 (a circular threaded hole) at a central upper end between the two slide grooves 111, 121, and two circular insert holes 14 positioned beneath the fixing hole 13 for two bolts 15 to be respectively inserted therethrough to firmly fix the foundation base 10 in the interior of the table sawing machine 100. Furthermore, the foundation base 10 is bored with a circular position-limiting hole 161 at a proper location between the fixing hole 13 and the slide groove 121, and a position-limiting pin 16 is inserted in the circular position-limiting hole 161, letting the front and the rear end of the position-limiting pin 16 respectively extended out of the position-limiting hole 161.

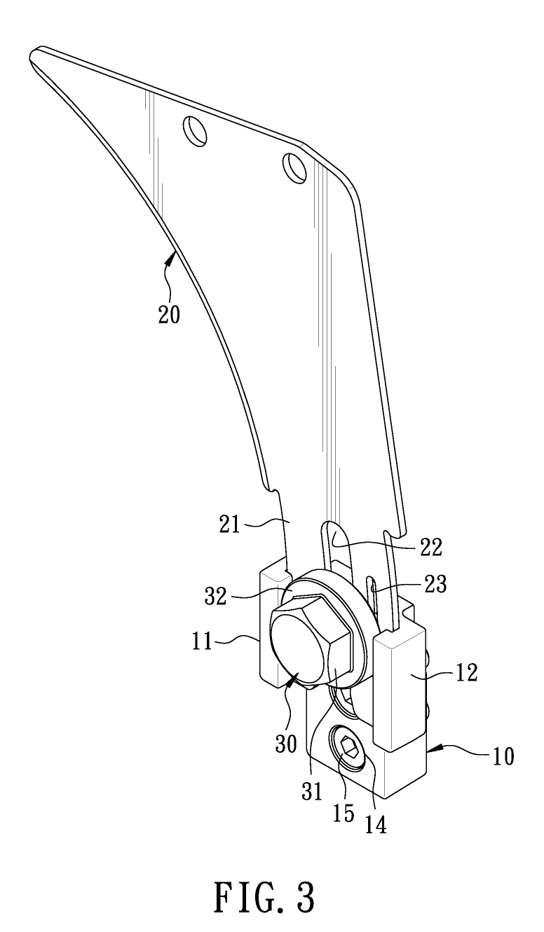

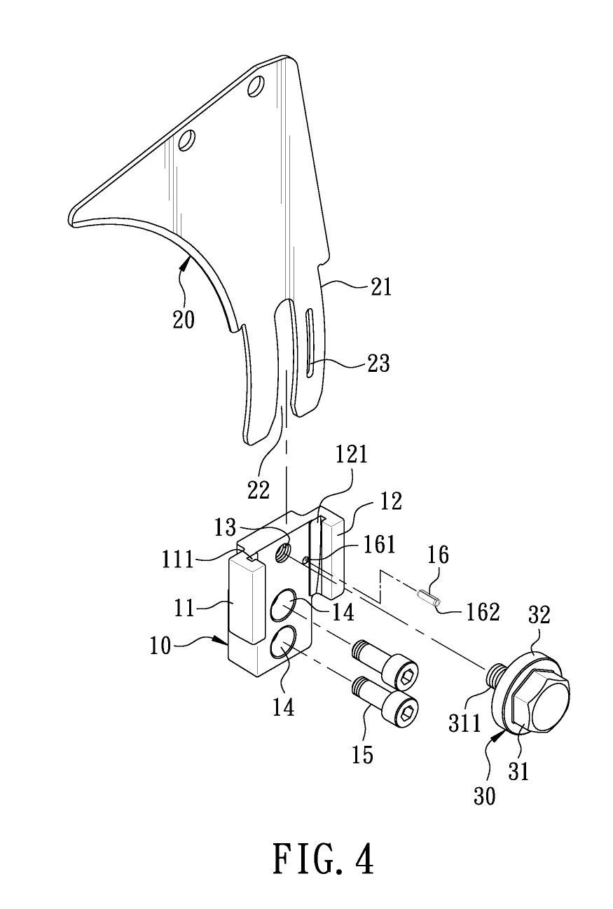

The separating plate 20, referring to FIGS. 3 and 4, has its inner circumferential edge adjacent to the circular saw blade 101 formed with a curved line matching with the outer circumference of the circular saw blade 101 and its lower end extended downward to form a combining member 21 whose width can exactly be received between the two slide grooves 111, 121. The combining member 21 of the separating plate 20 has its left and right sides respectively formed with a curved shape matching with the shape of the two slide grooves 111, 121 to enable the combining member 21 to be slidably inserted in the two slide grooves 111, 121. Further, the combining member 21 has an intermediate portion longitudinally cut with an oval and curved long notch 22 at a location corresponding to the fixing hole 13, and one side longitudinally bored with a long oval position-limiting slot 23 at a location corresponding to the position-limiting pin 16. The length of the position-limiting slot 23 forms a moving path for the separating plate 20 to shift up and down therein, restricted by the position-limiting pin 16 fitting in the slot 23.

The fixing member 30 is secured with a bolt 31 having its end formed with a threaded rod 311 to be inserted through the long notch 22 of the chopper plate 20 and secured in the fixing hole 13 of the foundation base 10 for tightly fixing the separating plate 20 on the foundation base 10. The bolt 31 of the fixing member 30 is provided thereon with a fixing ring 32 at a location contacting with the combining member 21 for pushing against the front side of the combining member 21 of the separating plate 20.

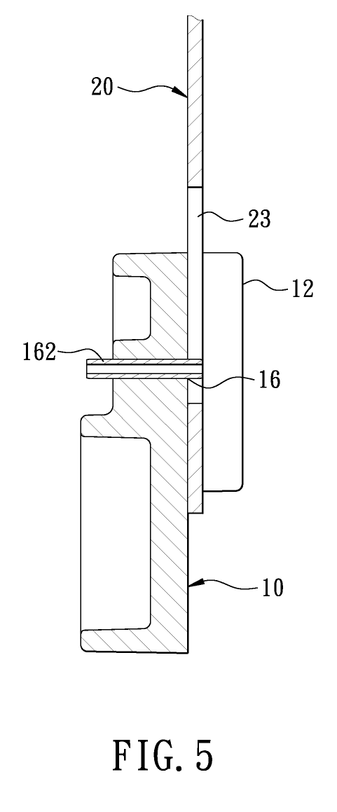

In addition, referring to FIG. 5, the position-limiting slot 23 of the separating plate 20 is restrictedly positioned on the front end of the position-limiting pin 16 extending out of the position-limiting hole 161 to let the separating plate 20 restricted in position by the front end of the position-limiting pin 162 in the position-limiting slot 23 and enable the separating plate 20 to be moved up and down on the front side of the foundation base 10 along the position-limiting slot 23.

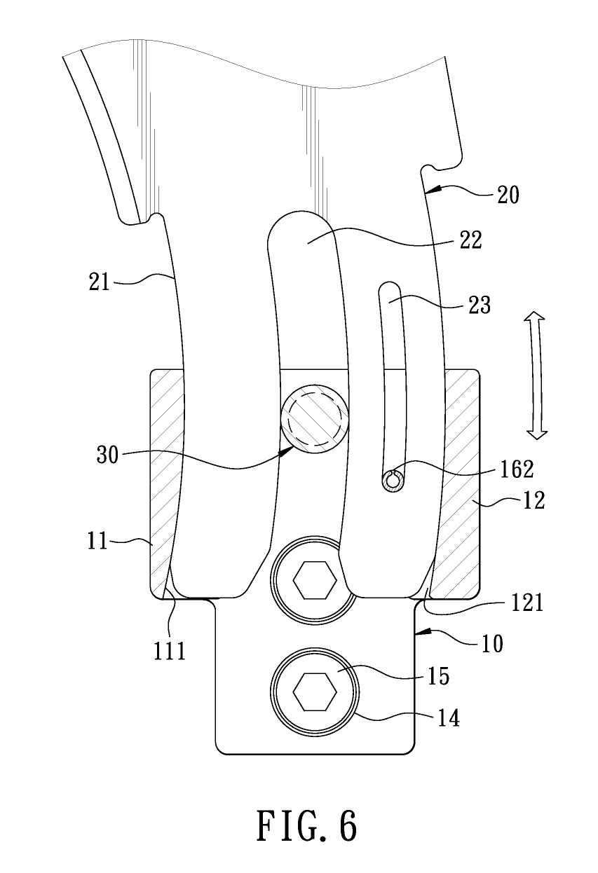

When the table sawing machine is to be used for carrying out processing of a wooden piece, the two bolts 15 are respectively inserted through the two insert holes 14 of the foundation base 10 and locked at a lower end of the right side of the outer circumference of the circular saw blade 101 inside the table sawing machine. When the separating plate 20 of this invention is to be used for cutting off a wooden piece, referring to FIG. 6, the fixing member 30 is unscrewed and disengaged from the fixing hole 13 of the foundation base 10, letting the separating plate 20 able to be adjusted and the fixing member 30 able to slide along the long notch 22 of the chopper plate 20. At this time, the separating plate 20 restricted in position by the position-limiting pin 16 can be longitudinally moved on the front side of the foundation base 10 along the position-limiting slot 23 and synchronously shifted along the outer circumferential path of the circular saw blade 101 by means of the two slide grooves 111, 121 at the opposite ends of the foundation base 10. Thus, the separating plate 20 can be adjusted and shifted upward to let the position-limiting pin 16 block the bottom end of the position-limiting slot 23 of the separating plate 20 and at this time, the separating plate 20 is exactly at a proper location higher than the topside of the circular saw blade 101. Then, the fixing member 30 is tightly locked in the fixing hole 13 of the foundation base 10 and thus the separating plate 20 can be used as a dividing plate for the wooden piece to be sawed.

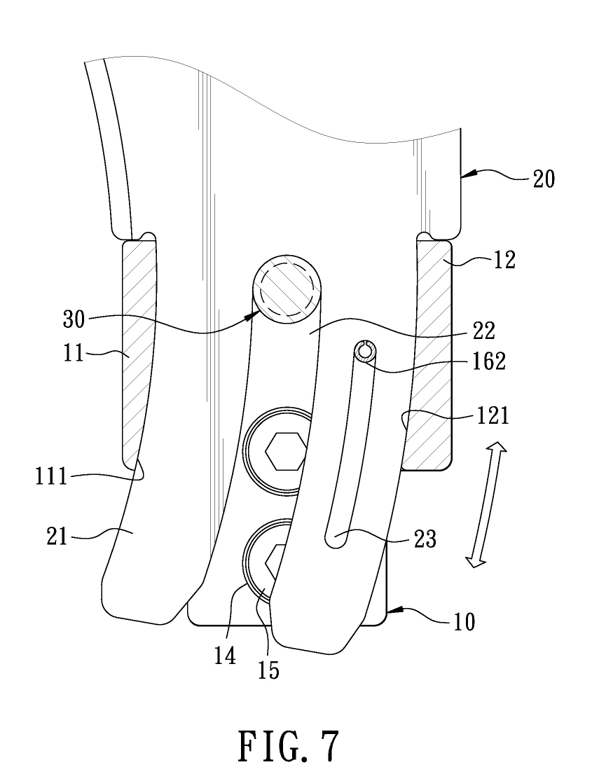

When the table sawing machine is to be used for cutting a wooden piece with a recess, referring to FIG. 7, the fixing member 30 is unscrewed and disengaged from the fixing hole 13 of the foundation base 10 to enable the separating plate 20 to be adjusted in position. Then, the separating plate 20 restricted in position by the position-limiting pin 16 is moved downward along the position-limiting slot 23 and at the same time adjusted to shift downward along the outer circumferential path of the circular saw blade 101 by means of the two opposite slide grooves 111, 121 of the foundation base 10, letting the position-limiting pin 16 block the top end of the position-limiting slot 23 of the separating plate 20, and at this time the separating plate 20 is exactly at a proper location somewhat lower than the topside of the circular saw blade 101. Subsequently, the fixing member 30 is firmly locked in the fixing hole 13 of the foundation base 10, and thus the separating plate 20 can be used for letting the circular saw blade 101 cut the wooden piece with a recess.

When the chopper plate 20 is unused, simply unscrew the fixing member 30 and disengage it from the fixing hole 13 of the foundation base 10 and then move the position-limiting pin 16 out of the position-limiting slot 23 and thus the separating plate 20 can be removed off. When the separating plate 20 is to be used, the combining member 21 of the separating plate 20 is first inserted in the two slide grooves 111, 121 of the foundation base 10, and the position-limiting pin 16 is restrictedly positioned in the position-limiting slot 23 of the separating plate 20. Then, the fixing member 30 is inserted through the long notch 22 of the chopper plate 20 and secured in the fixing hole 13 to fix the separating plate 20 on the foundation base 10.

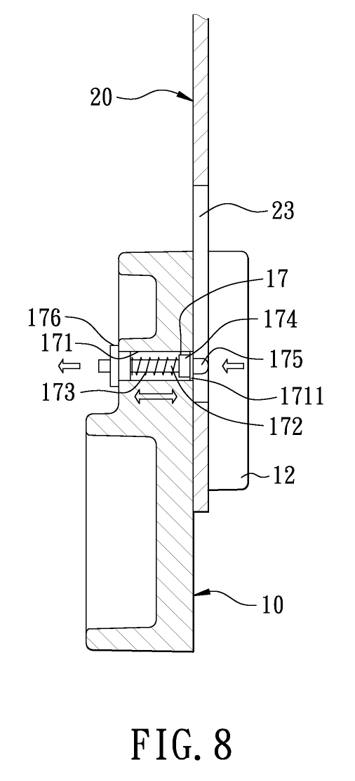

A second preferred embodiment of an adjustable chopper plate for a table sawing machine in the present invention, as shown in FIG. 8, has almost the same structure and function as those described in the first preferred embodiment, except that the foundation base 10 is bored with a position-limiting hole 171 for a position-limiting rod 17 to be inserted therethrough. The position-limiting hole 171 is inserted therein with the position-limiting rod 17 having a compression spring 173 fitted thereon and having its front end fixed with a stop ring 174 for blocking a stop wall 1711 disposed at a lateral side of the chopper plate 20 and positioned in the position-limiting hole 171. The position-limiting member 17 is provided with a position-limiting end 175 to fit in the position-limiting slot 23 of the chopper plate 20 to be restrictedly positioned in the position-limiting slot 23. The position-limiting rod 17 has its rear end fitted thereon with a position-limiting sleeve 176 having the outer circumference of its front end pushing against the inner circumferential wall of the position-limiting hole 171, and the position-limiting rod 17 is extended in the position-limiting sleeve 176. Thus, when the position-limiting end 175 is pushed from the interior of the position-limiting slot 23 of the separating plate 20, the stop ring 174 will be driven to press against the compression spring 173, and the position-limiting rod 172 will be actuated to move horizontally toward the outside of the position-limiting hole 171 to let the position-limiting end 175 quickly retreat backward and disengaged from the position-limiting slot 23 of the separating plate 20, thus enabling the separating plate 20 to be disassembled quickly.

As can be understood from the above description, this invention has the following advantages.

1. The separating plate is restrictedly positioned by the position-limiting pin of the foundation base and secured on the front side of the foundation base by the fixing member. After the fixing member is unscrewed, the separating plate can be slidably moved up and down on the front side of the foundation base along the position-limiting slot, and after the separating plate is adjusted and positioned at a proper height, the fixing member is locked in position anew to secure the separating plate on the foundation base. By so designing, the separating plate can be used for letting a work piece cut with a recess or cut into separate pieces, having multiple functions.

2. The separating plate can quickly be removed from the foundation base only by unscrewing the fixing member and disengaging the position-limiting pin from the position-limiting slot of the separating plate, easy and quick in disassembling and operating of the chopper plate, and simple in structure.

3. The two slide grooves at the opposite ends of the foundation base are long and curved grooves matching with the curved outer circumference of the circular saw blade; therefore, the separating plate can be shifted along the outer circumferential path of the circular saw blade, able to maintain a proper distance between the separating plate and the circular saw blade.

While the preferred embodiments of the invention have been described above, it will be recognized and understood that various modifications may be made therein and the appended claims are intended to cover all such modifications that may fall within the spirit and scope of the invention.

I claim:

1. An adjustable separating plate for a table sawing machine comprising:
a foundation base secured in the interior of a table sawing machine, said foundation base having two opposite ends of one side respectively and longitudinally bored with a slide groove, said foundation base provided with a fixing hole and a position-limiting pin at proper locations;
a separating plate having its lower end slidably positioned in said slide grooves of said foundation base, said separating plate having its lower end longitudinally bored with a long notch with a downward opening at a location corresponding to said fixing hole, said separating plate longitudinally bored a position-limiting slot at a location aligned to said position-limiting pin, said position-limiting slot restrictedly positioned by said position-limiting pin; and
a fixing member locked in said fixing hole of said foundation base, said fixing member inserted through said long notch for tightly fixing said separating plate in position.

2. The adjustable separating plate for a table sawing machine as claimed in claim 1, wherein said foundation base is bored with a position-limiting hole at a proper location for receiving said position-limiting pin to be fixed therein, said position-limiting pin extended in said position-limiting slot of said separating plate.

3. The adjustable separating plate for a table sawing machine as claimed in claim 1, wherein said foundation base is firmly assembled at one side of an outer circumference of a circular saw blade, and said slide grooves of said foundation base are long curved ones corresponding to an outer circumferential radian of said circular saw blade.

4. The adjustable separating plate for a table sawing machine as claimed in claim 3, wherein said separating plate has its circumferential edge opposite to outer circumference of said circular saw blade formed with a corresponding curved line and its lower end provided with a combining member, said combining member having its opposite sides respectively formed with a curved shape matching with a shape of said slide groove, said separating plate slidably positioned on said foundation base by means of said combining member.

5. The adjustable separating plate for a table sawing machine as claimed in claim 1, wherein said fixing hole of said foundation base is a threaded one and said fixing member is a bolt.

6. The adjustable separating plate for a table sawing machine as claimed in claim 1, wherein said foundation base is further bored with a position-limiting hole at a proper location for receiving said position-limiting pin, said position-limiting hole inserted therein with a position-limiting rod, said position-limiting rod fitted thereon with a compression spring, said position-limiting rod having one end fixed with a stop ring for blocking a stop wall provided at a lateral side of said separating plate and positioned in said position-limiting hole, said position-limiting rod disposed with a position-limiting end to fit in said position-limiting slot of said separating plate, said position-limiting end restrictedly positioned in said position-limiting slot, said position-limiting rod having another end firmly fitted with position-limiting sleeve, said position-limiting sleeve having an outer circumference of its front end pushing against an inner circumferential wall of said position-limiting hole.
